(19) United States
(12) Patent Application Publication
(10) Pub. No.: US 2025/0277129 A1
(43) Pub. Date: Sep. 4, 2025

(54) CORROSION PROTECTION IN AN AGRICULTURAL ENVIRONMENT

(71) Applicant: The Patent Well LLC, Fort Worth, TX (US)

(72) Inventors: Jeff Busby, Millsap, TX (US); Chad Knight, Dodd City, TX (US)

(21) Appl. No.: 19/065,862

(22) Filed: Feb. 27, 2025

Related U.S. Application Data
(60) Provisional application No. 63/560,231, filed on Mar. 1, 2024.

(51) Int. Cl. C09D 175/02; C23F 11/173

(52) U.S. Cl. CPC C09D 175/02; C23F 11/173

(57) ABSTRACT

A polymer corrosion protection coating for application to the surface of a vehicle, implement, equipment or structure that is subject to an agricultural, farm or ranch environment. The polymer coating is 2 part, rapid cure polyurea with a number of properties including resistance to ultraviolet light and impact.

### CROSS-REFERENCE TO RELATED APPLICATION

This application claims priority from U.S. Patent Provisional Application No. 63/560,231 (attorney docket no. P-103786.48PRO) filed Mar. 1, 2024, which is hereby incorporated. This application further incorporates U.S. Patent Application Publication No. 20170282196.

### BACKGROUND OF THE INVENTION

### Field of the Invention

A polymer coating for providing corrosion protection to a coated or bare metal surface or non-metal surface that is exposed to an agricultural environment and/or agricultural use.

### Description of the Related Art

Agricultural environments, including farms and ranches, often expose metal surfaces to a wide variety of physical and chemical conditions and thus present a challenge for protecting those surfaces from corrosion.

Metal surfaces that may be found in agricultural environments include surfaces on vehicles, implements, equipment, and structures. Vehicles include cars, trucks, trailers, tractors, railroad cars, ATVs, recreational vehicles (RVs), UTVs, and the like and parts therefor or parts thereof. Implements include hand tools and assemblies that engage tractors that are designed to engage the ground or spread seed or fertilizer, such as tillers, fertilizer spreaders, hoppers, bailers, and plows and the like and parts therefor and parts thereof. Equipment includes sprinklers, buckets or other containers, hay racks, tanks, horse trainers, fences, cattle chutes, water troughs, and the like, including parts thereof and parts therefor. Structures include storage buildings, water tanks, fencing assemblies, farms, horse stalls, windmills, and the like, as well as parts thereof and parts therefor. All the foregoing and similar vehicles, implements, equipment, and structures are sometimes referred to as VIES.

### SUMMARY OF THE INVENTION

Applicant has identified factors involved with corrosion of metal surfaces in an agricultural environment and has developed polymer compositions and methods for use of such compositions with properties designed to address the same.

The compositions in at least one embodiment include a polyurea two-part composition, with resin and curing agent or hardener with inert or active additives that address factors related to outdoor use and corrosion, including UV exposure, impact and chip resistance, fertilizer, salt, and/or animal waste resistance. In some embodiments, no corrosion is seen after 3000 salt fog exposure, B117.

Polymer compositions, including two-part polyureas, may be formulated with a variety of different physical and chemical properties, including hardness, viscosity, elongation, adhesion (impact strength), tensile strength, cure rate, gel time, impact or chip resistance, resistance to degradation and resistance to microbial, plant and animal attack.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 illustrates a spray assembly for use in applying Applicant's compositions to various surfaces, including Applicant's two-part cure-in-place polyureas, in accordance with one implementation of the present invention;

FIGS. 2 through 6 illustrate the use of Applicant's polyurea compositions on a structure such as a metal barn, in accordance with one implementation of the present invention;

FIGS. 7 through 10 illustrate the use of polyurea compositions on vehicles such as farm trailers, in accordance with one implementation of the present invention;

FIG. 11 illustrates the use of polyurea compositions on equipment, such as a multi-piece corral fence, in accordance with one implementation of the present invention; and

FIG. 12 illustrates the use of polyurea compositions on implements such as a landscape rake, in accordance with one implementation of the present invention.

The use of the same reference symbols in different drawings indicates similar or identical items.

### DESCRIPTION OF THE PREFERRED EMBODIMENT(S)

The following are details of various embodiments of the compositions of the invention as well as various environments for use that the compositions may be suitable for. In reference to usage of the disclosed, VIES refers to different environments.

One embodiment suitable for agricultural (VIES) usage is a polyurea with a gel time of 3 to 12 minutes, which is slower than most polyureas. The polyurea may be tack free in 30 to 60 minutes or less and cure (85% of full hardness, 72° F., 50% relative humidity) in 1 to 24 hours. Typically, Applicant's polyureas are free of VOCs (100% solids) or low VOCs (a level below 5 g to 10 g of VOCs per liter of coating composition). Here, some embodiments have a gel time of 1 minute to 20 minutes in another range, 1 to 10 minutes. Cure and gel times may be extended by adding solvents such as tertiary butyl acetate.

Ultraviolet light inhibitors may be added to the polyurea, including very fine (1 to 150 microns longest dimension) carbon black particles (spherical, flake, or granular) loaded in some embodiments 0.1 to 2.5% of final cured composition weight. Suitable flame retardants may be added to one or both parts of the precured polyurea.

Hardness, in some embodiments may be between Shore D 30-80 after 5 min-2 hours post mix (71F, 50%. In other embodiments, between Shore D 50 and 70.

Peel strength, in some embodiments, may be between 10 and 70 piw (clean, dry, bare Al 6061 T-3, 1″ wide, ⅛″ thick, 90° peel back) or in other embodiments in the range of 20 to 45 piw. Adhesion modifiers may be added to the mix and may improve adhesion to bare or coated metal surfaces (including steel and aluminum, for example) or painted surfaces, either of which may be sanded or otherwise abraded before application of the polyurea compositions.

Elongation may be in the range of 100% to 400% or, in another range, 150% to 250% with a tensile strength of 4000 psi or in the range of 2500 to 7500 psi (ASTM D412).

Applicant has found that the combination of peel strength and the ranges indicated, as well as hardness and tensile strength in the ranges indicated, are particularly favorable for providing sufficient impact resistance even when subject to harsh chemical environments and the impact of the hooves of animals such as cattle and horses.

A premix viscosity of between 1500 and 4400 cps (or 750-2200 cps) for the resin and 360-900 cps (or 180-450 cps) for the hardener (50/50 mix) has proven to provide for effective spray, brush, roll on, or injectable application to metal surfaces.

It has been shown through experimentation and testing that polyurea compositions with the above components and properties achieve sufficient impact resistance, mechanical and chemical degradation resistance, and critter resistance to be useful as a corrosion-inhibiting coating when applied to a metal surface and subject to an outdoor agricultural environment.

### Impact Resistance, Ball Drop Test

1. Product: AG2470 FCB, 2 part fast cure polyurea, with the properties set forth herein, from KBS Chemical, Dodd City, Texas.
2. 2.4 lb (1.09 kg) steel ball
3. 74 in (1.88 m) drop height
4. Potential Energy 20 Joules
5. 0.070 in thick sealant (0.050-0.100 in)
6. 0.032 in thick aluminum plate substrate. Impact of ball deformed aluminum substrate maximum about 0.075 in, product remained adhered to surface of aluminum (no lift off).
7. No visible damage, cracks, or significant distortion to the product.
8. Thickness change of product before and immediately after, less than 15%.
9. No sealant damage observed, minimal thickness change, passed ball drop impact test.

Degradation resistance may be measured and/or observed in various degradation environments. Degradation to UV light in polymers may be determined by degradation of mechanical properties such as tensile strength and elongation and may be observed, for example, by color change or surface breakdown. Degradation in animal waste, including horse and cattle manure and urine, may be determined by loss of mechanical properties, including hardness, change, cracking, elongation, tensile strength, and a material weight change after immersion.

Resistance to microbial attack as well as animal attack may be affected by using chemical aversion agents as set forth more fully below and may be measured or observed by degradation of mechanical properties and weight change. A number of chemical aversion agents can be used, mixed into one or both parts of the polymers before they are mixed to cure in place. These include peppermint oil, which acts as a safe rodent repellent, and capsaicin (in some embodiments, as microcapsules). These aversion agents may kill the rodent (rodenticides, such as brodifacoum or arsenic compounds) or be merely distasteful, like lithium chloride.

Biocides may be provided in the polymer. One biocide is Vinyzene® SB-1 PR a concentrate of 10,10′-oxybisphenoxarsine. The pelletized form can be ground and mixed with either or both sides of the polymers. The biocide may be mixed at 5% to 95% of the final cured weight of the polymer composition. Vinyzene® is also available in 1% and 2% solutions in plasticizers and solvents. Other examples of biocides are Zinc Omadine manufactured by Olin Chemical, Zinc Tryithione; and Intercide TMP by Akzochemie America, N-trichloromethylthiophthalimide. These compounds are exemplary of the biocides that can be used in this invention, and other biocides may be used. Other biocides may be found in U.S. Pat. Nos. 4,988,236 and 5,178,495 incorporated herein by reference.

Resistance to chemical and mechanical degradation upon exposure to animal waste (a mix of cow manure and cow urine) was qualitatively observed with daily exposure (at least 2 hours per day) of a 1/16th inch thick polyurea coating on steel over a period of 12 months. No material change in color or surface damage, swelling or cracks was observed in the visual examination of the product.

Additional ingredients that the polyurea may include are: antioxidants to help prevent degradation, thixotropes, rheology modifiers, texturizing agents and dispersants.

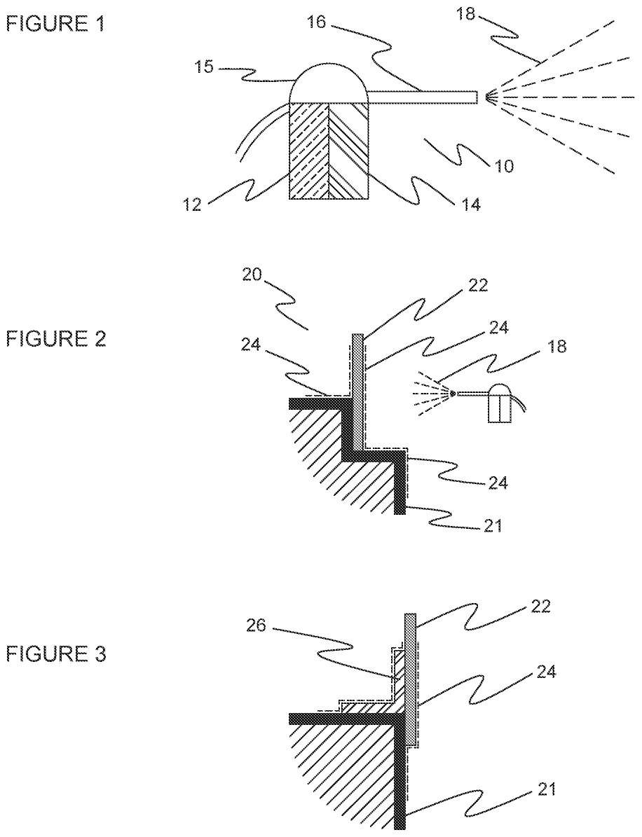

FIG. 1 illustrates a typical pneumatic spray assembly 10, which may include a first compartment 12 and a second compartment 14. The compartments typically carry a resin and an isocyanate in isolation from one another. The spray assembly may include a drive means 15 or forcing the two parts of the mix into a mixing device 16, such as a mixing straw. Typically, the polyurea spray 18 is emitted as an uncured, atomized mix under pressure.

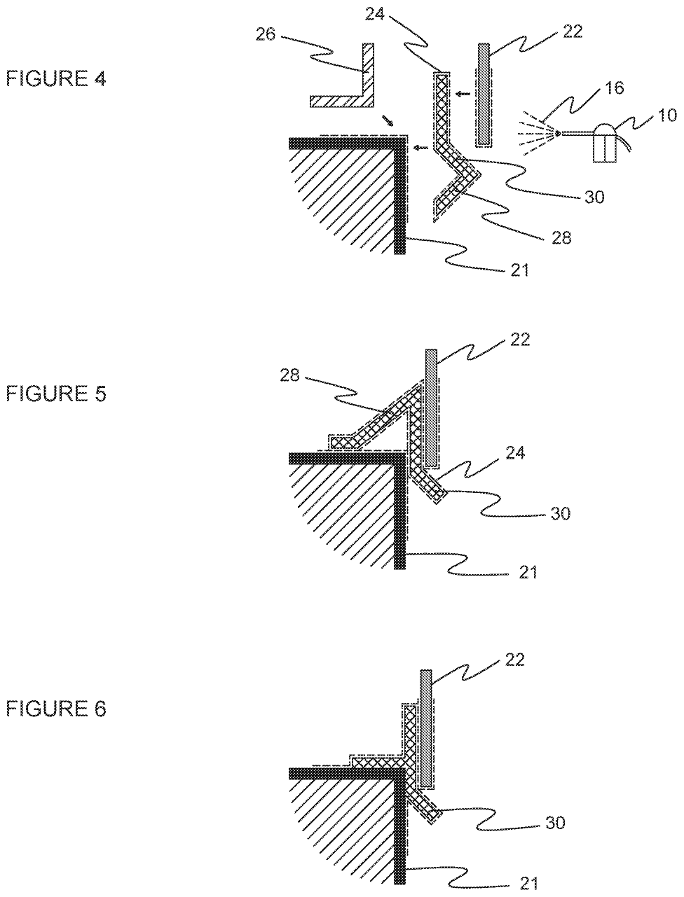

FIGS. 2 through 6 illustrate a structure 20, which could be a barn or other building having in some embodiments a foundation 21, such as a concrete foundation and metal walls 22. The spray assembly 10 is directed towards the structure, and the polyurea spray 18 strikes the structure and will cure to form a polyurea coat 24. Some parts of structure 20 are illustrated, including a metal bracket 26 and metal trim 28, having an angled member 30. It is seen from the illustrations how angled member 30 would direct water falling down the wall 22 away from the foundation.

FIGS. 2 through 6 show that several places are particularly susceptible to corrosion, including the lower edge of such buildings up to about 18″ off the ground. Also, inside the building, moisture condenses between the insulation and the inner surface of the wall. Both areas are particularly suitable for Applicant's compositions after the removal of any existing corrosion. Optionally, coating may be applied when the building components are made, such as the bottom 24″ of either or both sides of a wall.

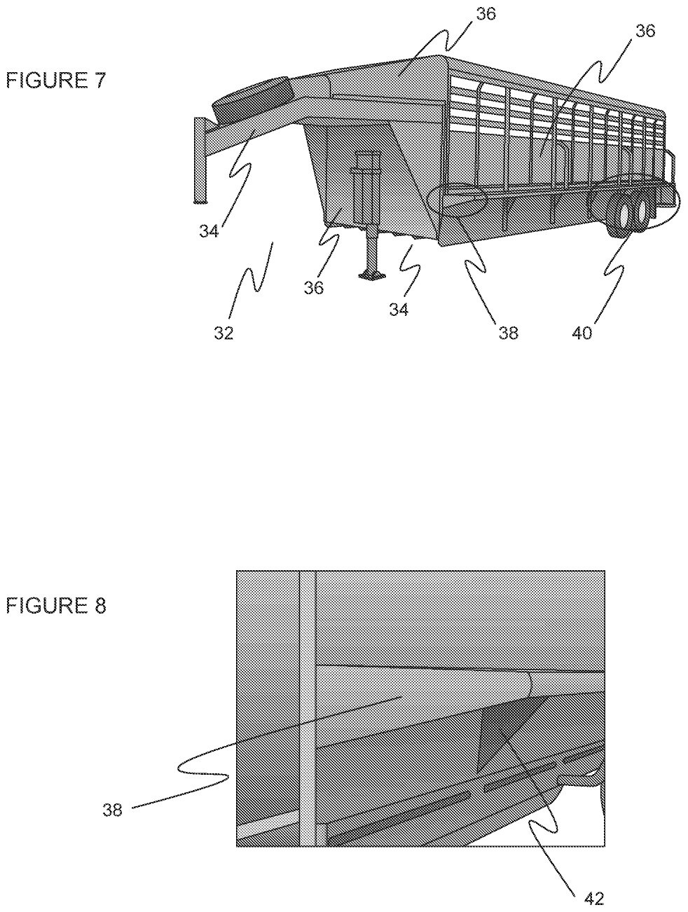

FIGS. 7 through 10 illustrate a vehicle, here a wheeled vehicle such as a gooseneck cattle or horse trailer 32. The vehicle may include frame members 34, which typically carry a significant portion of the load on the vehicle, and walls 36, which may be vertical. The vehicles may include wheel wells, brackets, beams, or other structural members 42, as well as flooring 44. In trailers designed to carry cattle and horses, there may be a rear livestock step 46 where livestock enter the rear of the trailer and onto the flooring 44. Flooring 44, step 46, and trailer doors 48 are especially high-wear areas likely to contact cattle, horses, or other livestock directly. Other high-wear areas are leading edges 38 and wheel well rear areas 40/50, both at risk of material thrown up from the road and impacting the vehicle.

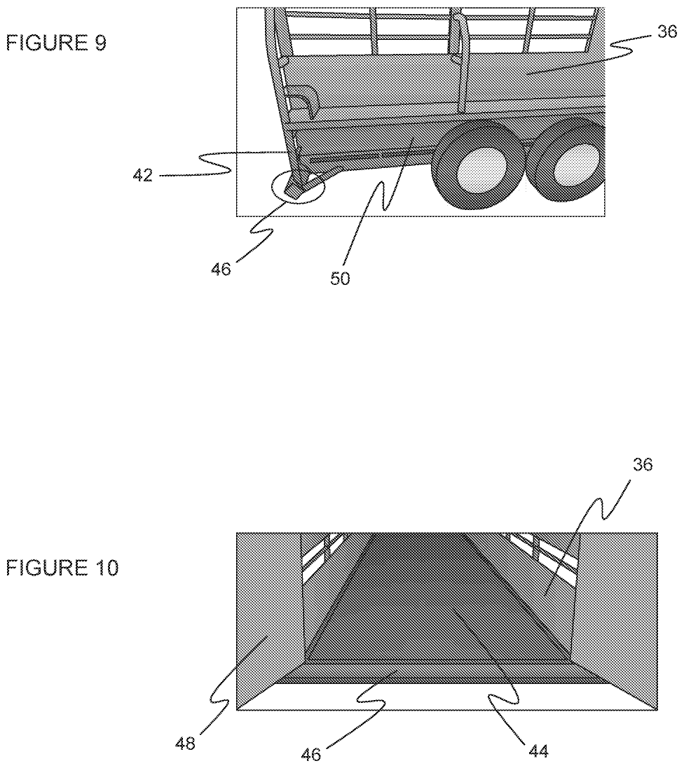

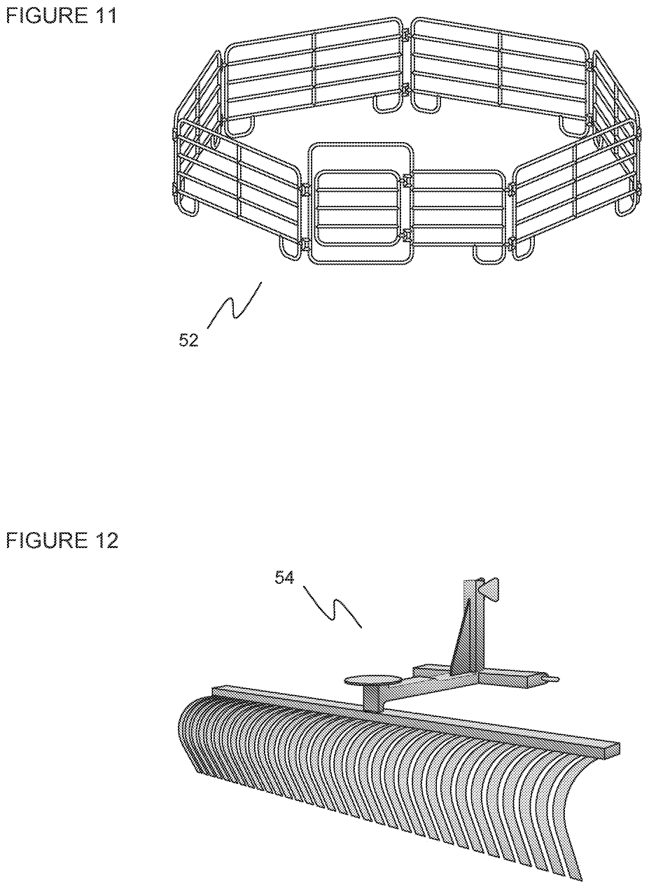

FIG. 11 illustrates ranch, farm, or other agricultural equipment 52, here, metal fencing/gates, cattle chutes, and squeeze chutes, including the lower members/walls thereof. FIG. 12 illustrates an example of an implement 54 here, a landscape rake that will attach to a tractor and typically comes into contact with the ground when in use.

The metal surface to which the polyurea is applied must be clean and dry. It may be blasted with or otherwise subjected to an abrasive media to help remove dirt, grease chemicals, rust, or prior coatings. Indeed, abrading the surface may help the coat better adhere.

Initial bare steel and aluminum coupons coated with 1/16th inch of Applicant's polyurea spray compositions in the ranges indicated showed no visible corrosion after 3000 hours of salt for exposure (ASTM B117). There was no material change in hardness of the product after salt fog exposure.

Typically, the areas to be sprayed are taped off from those that will not be sprayed. Applicant's relatively slow gel time allows one to remove the masking tape without disturbing the sprayed area if removal is done before the end of gelling. The spray gun may be held about 4 to 12 inches from the surface, and several courses may be applied, typically a first course and then, while the first course is tacky, a second and/or a subsequent course. A primer coat may be applied on the bare surface of the metal, such as a polyurethane or an epoxy primer to which the polyurea coat will be applied. A mesh, such as a fiberglass mesh, may be laid down onto the metal before the primer or polyurea coat or may be placed on the primer or topcoat before it cures. Optionally, a meshless coat of polyurea may be applied to the mesh layer. A mesh will help, especially in high-wear areas, to help reduce abrasion by mechanical means, such as impact with rocks or the hooves of livestock. Sand or other grit may be applied to an uncured coating to help prevent slipping and help prevent wear. Applicant has found that coating the outer and upper surfaces of vehicles (such as RV roofs) or structures can help prevent not only corrosion but also hail damage.

Initial observations indicate that Applicant's polymer compositions described herein may be suitable for sealing concrete and may be used on surfaces, including the inner surfaces of swimming pools or stock ponds.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A method of protecting a surface of a vehicle, implement, equipment or structure, the method comprising:
first providing a two-part, cure-in-place polyurea mix capable of curing in 5 minutes to 2 hours, (71° F., 50% RH) to Shore D 30-80 hardness and after 24 hours to an impact resistant polyurea coating;
applying the polyurea mix on to a surface of a vehicle, implement, equipment or structure for use in an agricultural environment; and
allowing the polyurea mix to cure.

2. The method of claim 1 further comprising second providing a device to apply the polyurea mix to the surface.

3. The method of claim 1 wherein the polyurea coating is resistant to degradation in animal waste.

4. The method of claim 1 wherein the polyurea mix includes carbon black as spheres, flakes or granules, loaded 0.1-2.5% of final polyurea coating weight.

5. The method of claim 1 wherein the polyurea coating has a hardness of between Shore D 30 and Shore D 80 after 24 hours (71F, 50% Relative Humidity).

6. The method of claim 1 wherein the polyurea coating has a peel strength of 10 to 70 piw (Al 6061, 1″ wide 90° peel back).

7. The method of claim 2 wherein the device of the second providing is a spray gun.

8. The method of claim 1 wherein the polyurea coating of the first providing passes 3000-hour salt fog test ASTM B117.

9. The method of claim 1 wherein the mix of the first providing is free of VOCs.

10. The method of claim 1 wherein the surface of the applying is bare metal.

11. The method of claim 1 further including, adding a topcoat to the polyurea coating.

12. The method of claim 1 wherein the polyurea mix of the first providing contains a chemical aversion agent and/or a biocide.

13. A method of protecting a surface of a vehicle, implement, equipment or structure, the method comprising:
first providing a pneumatic spray assembly having a first compartment and a second compartment, and a mixing straw, each compartment having one part of a two-part, cure-in-place polyurea mix capable of curing in 5 minutes to 2 hours, to Shore D hardness between 30-80 and after 24 hours to an impact resistant polyurea coating with an elongation between 100 and 400%;
spraying the polyurea mix on to a metal surface of a vehicle, implement, equipment or structure for use in an agricultural environment; and
allowing the polyurea mix to cure.

14. The method of claim 13 wherein the metal surface of the spraying includes a metal bracket, trim or lower wall of the structure.

15. The method of claim 13 wherein the metal surface of the spraying includes forward facing walls or wheel wells of a trailer.

16. The method of claim 13 wherein the metal surface of the spraying includes a floor, step or door of a cattle trailer.

17. The method of claim 13 wherein the metal surface of the spraying includes a fence, a cattle, a squeeze chute or a gate.

18. The method of claim 13 wherein the metal surface of the spraying includes a tractor implement.

19. The method of claim 13 wherein the polyurea mix includes carbon black and the metal surface of the spraying includes the upper and outer surface of a vehicle.

20. A method of protecting a surface of a vehicle, implement, equipment or structure, the method comprising:
first providing a pneumatic spray assembly having a first compartment and a second compartment, and a mixing straw, each compartment having one part of a two-part, cure-in-place polyurea mix capable of curing in 5 minutes to 2 hours, to Shore D hardness between 30-80 and after 24 hours to an impact resistant polyurea coating with an elongation between 100 and 400%;
spraying the polyurea mix on to a metal surface of a vehicle, implement, equipment or structure for use in an agricultural environment; and
allowing the polyurea mix to cure;
wherein the polyurea mix includes carbon black; and
wherein the metal surface is part of a trailer.
